(19) United States
(12) Patent Application Publication
(10) Pub. No.: US 2025/0326986 A1
(43) Pub. Date: Oct. 23, 2025

(54) METHOD FOR CONVERSION OF FREE FATTY ACIDS TO TRIACYLGLYCERIDE

(71) Applicants: Adeeb Hayyan Alrazzouk, Bolingbrook, IL (US); EcoNova Global Solutions, Bolingbrook, IL (US)

(72) Inventor: Adeeb Hayyan Alrazzouk, Kuala Lumpur (MY)

(21) Appl. No.: 19/185,517

(22) Filed: Apr. 22, 2025

Related U.S. Application Data
(60) Provisional application No. 63/636,984, filed on Apr. 22, 2024.

(51) Int. Cl. C11C 3/02

(52) U.S. Cl. CPC C11C 3/02

(57) ABSTRACT

The present invention comprises a new method conversion of free fatty acids (FFAs) to triacylglycerides (TAG) using organic solvents (methanol and ethanol) at mild conditions including organic solvent-to-oil molar ratio, reaction time, temperature, and mixing speed as parameters. The optimal conditions included a temperature of 40° C. to about 80° C., a 60-900 second reaction time and a specific mixing speed (1200 rpm). The present application illustrates the importance of precise control over variables in low grade vegetable oils processing and provides potential applications for economically viable and sustainable vegetable oil production beyond the food industry.

### FIELD OF THE INVENTION

Disclosed herein is an eco-friendly and green extraction technology and reaction for free fatty acid removal from acidic oils and fats using organic solvents. The present disclosure can be used for the treatment of vegetable oils and animal fats using different organic solvents under mild conditions to convert the FFA content in the vegetable oils and animal fats to triacylglyceride (TAG). Specifically, disclosed is a method for upgrading low grade vegetable oils to premium grade vegetable oils in a way that is rapid, safe and does not affect the FFA s profile.

### BACKGROUND

Sustainable and cutting-edge technology is a primary focus in various fields, including food production. As the demand for food resources rises and concerns about environmental impact grow, researchers are actively engaged in developing advanced technologies for greener food production. This shift is particularly crucial in light of the challenges faced by traditional food production methods and their environmental consequences. The goal is to synthesize and market food products using innovative methods that not only meet the increasing demand but also ensure profitability while minimizing costs. This dedication to advancing green and efficient technologies in food production reflects a commitment to addressing resource scarcity and environmental sustainability, ensuring a more resilient and responsible approach to meet global nutritional needs.

In response to the ongoing debates regarding the use of crops for food production and the imperative to reduce production costs, it is essential to explore new, abundant, and cost-effective sources for food production. Due to high FFAs level in low grade vegetable oils and animal fats, these raw materials can be considered as only acceptable for use as non-food feedstocks for industrial products, such as biodiesel. In addition, the treatment of waste cooking oil (WCO) or animal grease and agro-industrial raw materials (sludge palm oil, fatty acid distillates, soapstocks, acidic oil, low grade and by-products of vegetable oil refineries) required tedious technique or high-cost technology that utilize harsh chemicals, high temperature and/or pressure.

A significant challenge in utilizing low-grade feedstocks for food production lies in their high FFA content, which impacts the efficiency of the alkaline transesterification process due to its sensitivity to FFA and water content. Methods to upgrade these feedstocks result in inefficient use of alkaline catalysts like potassium hydroxide (KOH), sodium hydroxide (NaOH) and undesired saponification. For instance, crude palm oil with high FFAs or sludge palm oil are characterized as low-grade industrial oils, and this is mainly due to presence of FFAs in such acidic vegetable oils. Numerous processing techniques have been introduced to reduce FFA content, such as saponification, steam refining, glycerolysis and acid esterification. The saponification process, widely adopted in the industry, involves mixing a base such as NaOH with the low-grade oil, thereby converting FFA into soaps that are insoluble in oil. The resulting soap can then be separated, typically using a centrifuge. The saponification process is often integrated with the pretreatment process, minimizing the equipment required. However, saponification technique can be applied only for the raw materials with less than 5% FFAs and the technique requires precise control of alkaline loading to minimize oil loss.

Steam refining is another process widely used in vegetable oil refining industry for neutralizing fats and oils through steam stripping under vacuum. This method ensures the production of oil with extremely low FFA levels. However, an additional pretreatment, typically involving an adsorption process, is often required prior to steam refining. Despite its reliability, the steam refining process comes with some challenges as it demands higher temperatures or high pressure and specialized equipment with deeper vacuum capabilities. Consequently, these factors contribute progressively to the overall production costs. While effective in achieving high-quality oil with low FFA content, the steam refining process's intricacies and specific requirements underscore the need for careful consideration of the associated costs in large-scale oil refining operations.

In another approach, glycerolysis offers a route for processing FFA by converting the diglyceride and monoglyceride in presence of glycerol or glycerin into triglycerides or triacylglycerides. The glycerolysis process is used by mixing of glycerol with the FFA in the vegetable oil in the molar ratio of 1:1 to 1:3. Typically, glycerolysis is reversible reaction and the presence of catalyst such as NaOH or ZnO/MgO, is required for driving the reaction forward. The operating temperature for this process is recommended to be higher than 200° C. and it also requires longer reaction times ranging between 60 minutes to 1440 minutes. Similar to steam refining, the glycerolysis process demands specialized equipment due to its high-temperature or pressure requirements.

Acid esterification is one of the most typical and widely used processes in oleochemical production to convert FFA into fatty acid methyl esters (biodiesel) and water, using methanol or ethanol in presence of acidic catalyst. Excess alcohol is required for esterification reaction for the purpose of driving the reaction forward. However, this reaction requires strong corrosive catalysts such as sulfuric acid or p-toluenesulfonic acid, that can increase the total cost for the reactor/piping design and maintenance. Water is a byproduct of this reaction, and the water should be removed before biodiesel production. Additionally, this process requires special downstream processing units. Wastewater or effluent are generated from this process and, therefore, there are many environmental concerns for applying this process for biodiesel production. Reaction time and the reaction temperature are varied, depending on the activity of the acidic catalyst used and its dosage loading to the reaction.

Therefore, there is a need for a method to produce high-quality food oils while keeping production costs at a minimum. This present disclosure presents a promising method for the food industry, especially in the production of edible oils from animal and vegetable sources. It offers a cost-effective alternative to conventional techniques like saponification, steam reforming, acid esterification and glycerolysis. The disclosed method has the potential to provide practical solutions applicable across various food industries, enhancing the quality of acidic vegetable oils and fats to premium grade at room temperature. Moreover, these novel methods are recyclable, significantly reducing costs for producing large volumes of lower grade oils.

### BRIEF SUMMARY OF THE INVENTION

A first aspect of the of the invention includes methods for converting free fatty acids (FFAs) to triacylglyceride to decrease the FFA percentage in an acidic oil, comprising the steps of mixing an acidic oil with an organic solvent creating a neutralized oil, separating the neutralized oil from the organic solvent; and evaluating the neutralized oil for FFA content or pH.

A second aspect of the invention includes methods for recycling acidic consumable oils for reuse by converting the FFAs within the oil to be recycled to triacylglycerides to decrease the total FFA percentage in the oil.

In a second aspect of the method, the FFAs or monoglycerides and diglycerides present in the acidic oil are converted to triacylglycerides during the mixing.

In a third aspect of the method, the acidic oil is a vegetables oil, a waste cooking oil, or an animal fat.

In a fourth aspect of the method, the vegetable oil includes rapeseed oil, canola oil, soybean oil, camellia oil, algae oil, sesame oil, mustard seed oil, linseed oil, corn oil, crude palm oil, sludge palm oil, acidic crude palm oil, low grade palm oil, palm-kernel oil, jatrophra seed oil, Nahar (Mesua ferrea) seed oil, Balanites aegyptiaca seed oil, kenaf seed oil, squash seed oil, watermelon seed oil, pumpkin seed oil, cottonseed oil, safflower oil, perilla seed oil, black seed oil, cocoa seed oil, neem oil, rubber seed oil, flaxseed oil, argan oil, almond oil, hazelnut oil, paradise oil, copaiba oil, okra seed oil, babassu oil, castor oil, tung oil, microalgae oil, rice bran oil, coconut oil, poppy-seed oil, sunflower oil, castor oil, jojoba oil, avocado oil, seaweed oil, walnut oil, grape seed oil, peanut oil, olive oil.

In a fifth aspect of the method, the waste cooking oil includes, brown grease, yellow grease, choice white grease.

In a sixth aspect of the method, the animal fat includes, tallow, lard, poultry fat and fish oil.

In a seventh aspect of the method, the organic solvent is a C1 and C13 alcohol.

In an eighth aspect of the method, the organic solvent is ethanol.

In a ninth aspect of the method, the organic solvent is methanol.

In a tenth aspect of the method, the steps take place in atmospheric pressure.

In an eleventh aspect of the method, the ratio of organic solvent to acidic oil is about 40:1 to about 1000:1.

In a twelfth aspect of the method, the reaction time is about 60 seconds to 900 seconds.

In a thirteenth aspect of the method, the acidic oil is heated prior to mixing.

In a fourteenth aspect of the method, the acidic oil is heated to about 40° C. to about 80° C. prior to mixing.

In a fifteenth aspect of the method, ratio of organic solvent to acidic consumable oil is about 40:1 to about 1000:1.

In a sixteenth aspect of the method, after separation in step, the organic solvent is recycled for use again in the mixing step.

In a seventeenth aspect of the method, the organic solvent is recycled 1 to 10 times.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1—shows an exemplary flowchart of the reaction conversion of free fatty acids (FFAs) to triacylglycerides (TAG) using organic solvents at mild conditions.

FIG. 2—shows a graphical representation of an effect of reaction time according to various embodiments described herein.

FIG. 3—shows a graphical representation of an effect of a reaction temperature according to various embodiments described herein.

FIG. 4—shows a graphical representation of an effect of mixing speed according to various embodiments described herein.

FIG. 5—shows a graphical representation of the recyclability of the crude palm oil (CPO) upon mixing with ethanol according to various embodiments described herein.

FIG. 6—shows a graphical representation of the recyclability of the crude palm oil (CPO) upon mixing with methanol according to various embodiments described herein.

FIG. 7—shows first-order kinetic model for methanol reaction upon mixing with crude palm oil (CPO) according to various embodiments described herein.

FIG. 8—shows first-order kinetic model for ethanol reaction upon mixing with crude palm oil (CPO) according to various embodiments described herein.

FIG. 9(a) and 9B)—shows Nuclear magnetic resonance spectroscopy (NMR) results of (a) crude palm oil (CPO) and (b) treated oil when mixing with methanol according to various embodiments described herein.

FIG. 10—shows Fourier-transform infrared spectroscopy (FTIR) results of crude palm oil (CPO) and treated oil when mixing with methanol according to various embodiments described herein.

### DETAILED DESCRIPTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting but merely as a basis for claims. It should be understood that the drawings and detailed description thereto are not intended to limit the invention to the particular form disclosed, but on the contrary, the invention is to cover all modification, equivalents and alternatives falling within the spirit and scope of the present invention as defined by the appended claims.

A s used throughout this application, the word “may” be used in a permissive sense (i.e., meaning having the potential to), rather than the mandatory sense (i.e., meaning must). Similarly, the words “include,” “including,” and “includes” mean including, but not limited to. Further, the words “a” or “an” mean “at least one” and the word “plurality” means one or more, unless otherwise mentioned. Where the abbreviations of technical terms are used, these indicate the commonly accepted meanings as known in the technical field. Further, the words “a” or “an” mean “at least one” and the word “plurality” means one or more, unless otherwise mentioned. Where the abbreviations of technical terms are used, these indicate the commonly accepted meanings as known in the technical field.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and claims.

New method for conversion of free fatty acids (FFAs) in low grade vegetable oils to triacylglyceride (TAG) using organic solvents in mild conditions are discussed herein. In the following description, for purposes of explanation, numerous specific details are set forth in order to provide a thorough understanding of the present invention. It will be evident, however, to one skilled in the art that the present invention may be practiced without these specific details.

As used herein, the term acidic oil means an oil or fat with FFA above 3%. Acidic acids may also be referred to as low grade oils, low grade feedstocks, waste oils, etc. The disclosed method may be used for consumable oils such as vegetable oil, a waste cooking oil, or an animal fat which are acidic due to a FFA composition above 3%. In the experiments and embodiments described herein crude palm oil (CPO) was used as the acid oil for analysis because of its high FFA content. Those of skill in the art would appreciate that the exemplary methods described herein using CPO as the acid oil would be applicable to other acidic oils as well.

Vegetable oils for use in the present method may include one or more of rapeseed oil, canola oil, soybean oil, camellia oil, algae oil, sesame oil, mustard seed oil, linseed oil, corn oil, crude palm oil, sludge palm oil, acidic crude palm oil, low grade palm oil, palm-kernel oil, jatrophra seed oil, Nahar (Mesua ferrea) seed oil, balanites aegyptiaca seed oil, kenaf seed oil, squash seed oil, watermelon seed oil, pumpkin seed oil, cottonseed oil, safflower oil, perilla seed oil, black seed oil, cocoa seed oil, neem oil, rubber seed oil, flaxseed oil, argan oil, almond oil, hazelnut oil, paradise oil, copaiba oil, okra seed oil, babassu oil, castor oil, tung oil, microalgae oil, rice bran oil, coconut oil, poppy-seed oil, sunflower oil, castor oil, jojoba oil, avocado oil, seaweed oil, walnut oil, grape seed oil, peanut oil, or olive oil.

Waste cooking oil for use in the method disclosed herein include, brown grease, yellow grease, choice white grease.

Animal fats for use in the method disclosed herein include, tallow, lard, poultry fat and fish oil.

Organic solvents for use in the present method include C1, C2, C3, C4, C5, C6, C7, C8, C9, C10, C11, C12 and C13 alcohols. Preferably the organic solvent is methanol (C1 alcohol) or ethanol (C2 alcohol).

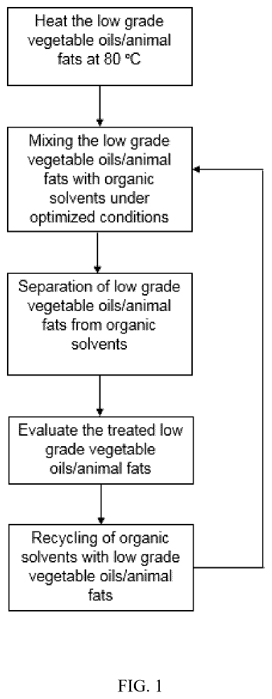

The present invention will now be described by referencing the appended figures representing preferred embodiments. FIG. 1 shows the detailed reaction conversion of free fatty acids (FFAs) to triacylglycerides (TAG) using organic solvents (methanol and ethanol) at mild conditions. As shown in FIG. 1, an acidic oil, such as a low-grade vegetable oil or animal fat, is mixed with an organic solvent. The acidic oil may be at room temperature or, optionally, the acidic oil may be heated to prior to mixing. The mixing of the acidic oil with an organic solvent creates a neutralized oil. The neutralized oil has a reduced percentage of free fatty acids in the oil. The neutralized oil is then separated from the organic solvent. The neutralized oil is evaluated to confirm whether or not the desired reduction in FFA composition has been reached. Optionally, the separated organic solvent is recycled and mixed with a fresh volume of acidic oil.

Unlike prior art method for reducing FFAs in an acidic oil, the present method is conducted at atmospheric pressure and does not require additional pressure to be applied to the reaction.

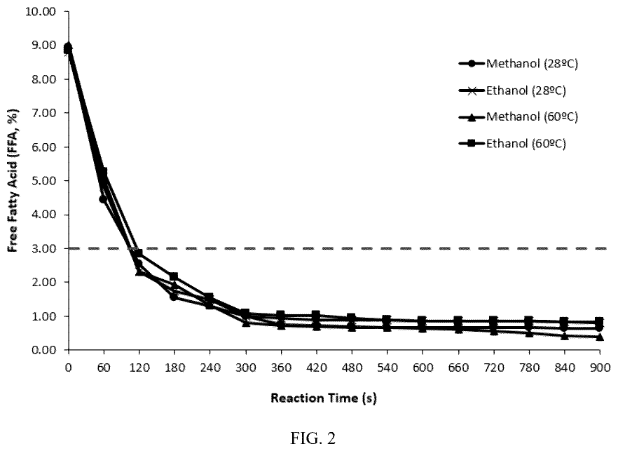

In preferred embodiments, FIG. 2 presents the effect of reaction time based on an experiment conducted under specific conditions. The result demonstrates that after 120 seconds, the FFA level was reduced below 3%, indicating the alcohols' ability to quickly react and convert FFA after 120 seconds. Furthermore, the study was extended up to 900 seconds to observe the trend of FFA level reduction. It was observed that the FFA level continued to decrease as the reaction time was prolonged, which signifies that longer reaction times can achieve the desired reduction in FFA content. One of skill in the art will appreciate that reaction times ranging from about 60 seconds to 900 seconds may be achievable with the disclosed method.

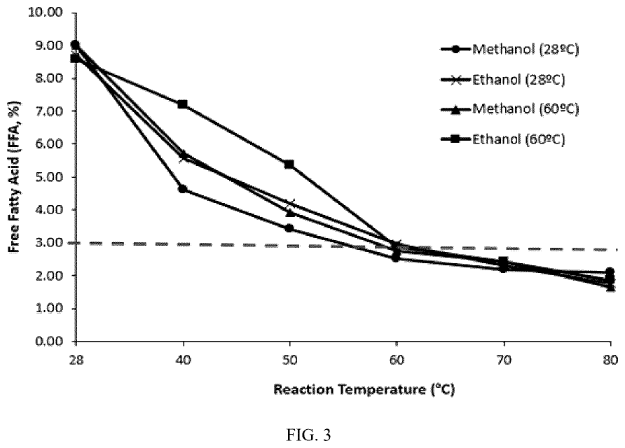

In preferred embodiments, FIG. 3 showed that at ambient temperature (28° C.), a high loading of methanol and ethanol can effectively reduce FFA levels to below 3%. Conversely, a low loading of methanol and ethanol required a higher temperature of 60° C. to achieve the same level of FFA reduction. These findings support organic solvent to oil molar ratio studies that suggest higher temperatures can reduce FFA levels, and the results showed that 60° C. was sufficient to achieve FFA levels below 3%, even when increasing the temperature to 80° C. Therefore, the study demonstrated the feasibility of using methanol and ethanol at either around ambient temperature 28° C. (with a high loading) or higher temperature, at or above 60° C. (with a low loading) to effectively reduce FFA levels in crude palm oil.

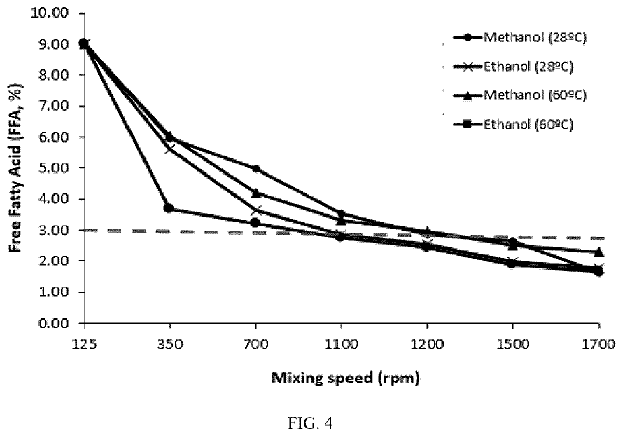

In preferred embodiments, FIG. 4 shows the effect of mixing speed on crude palm oil was investigated from 125 rpm to 1700 rpm for 2 minutes. The study found that the mixing speed has a significant effect on reducing the FFA levels in crude palm oil during the alcohol-esterification process. The required mixing speed to achieve FFA levels below 3% varied depending on the alcohol loading and the resulting reaction rate. At higher methanol and ethanol loading (28° C.), a mixing speed of 1100 rpm was sufficient to reduce FFA levels below 3%, possibly because the reactant was more readily available, leading to a faster reaction rate and lower required mixing speed. In contrast, at lower organic solvents loading (60° C.), a higher mixing speed of 1200 rpm was needed to achieve the same FFA reduction. The experiment of FIG. 4 was conducted with crude palm oil as the acidic oil. The need for higher mixing speeds may have been more pronounced for the crude palm oil at ambient temperature, possibly because the crude palm oil was more viscous, making it harder to mix, and the reaction rate was slower due to lower availability of the reactant.

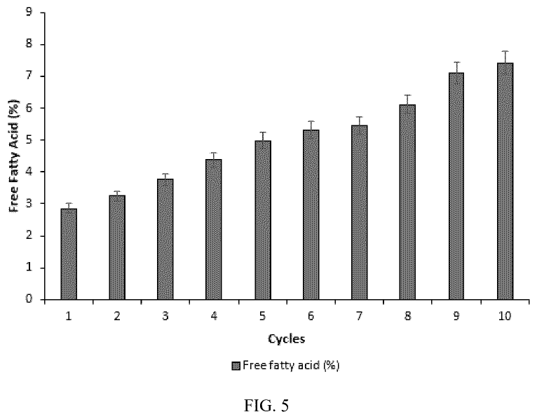

In preferred embodiments, FIG. 5 demonstrated recyclability study of organic solvent (ethanol) with crude palm oil (CPO) at mild conditions. As shown in FIG. 5, as the number of cycles of reuse of the organic solvent increases, the percentage of FFAs in the oil also increases. This suggests that the efficiency of the process decreases with each successive cycle, resulting in a higher content of FFAs in the final product. Despite the FFA percentage reaching almost 3.76% at the 3^{rd} cycle, the reused ethanol is still considered acceptable up to 50% oil recovery efficiency. One of skill in the art would understand that, despite the increase in FFAs, the overall efficiency of the process is still satisfactory until it falls below 50%.

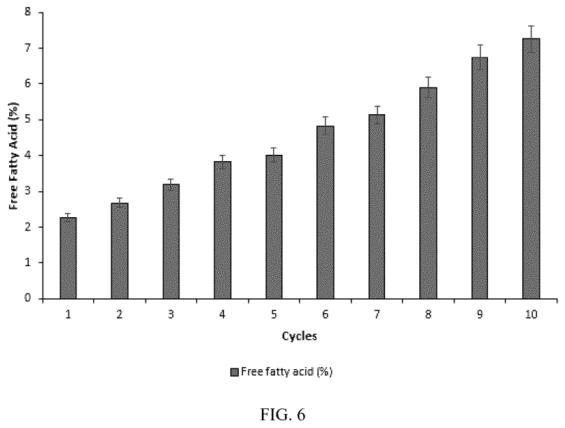

In preferred embodiments, FIG. 6 demonstrated recyclability study of crude palm oil (CPO) using organic solvent (methanol) at mild conditions. Similar to organic solvent ethanol, as the number of cycles of reuse increases, there is a noticeable increase in the percentage of free fatty acids (FFAs) in the oil. The graph suggests that methanol can be recycled for up to four cycles while maintaining acceptable oil recovery efficiency of up to 50%. This indicates that despite the rise in FFAs, the process remains satisfactory until its efficiency drops below 50%. A person of skill in the art would appreciate that, while recovery efficiency such as shown here may be achieved according to the present disclosure, the efficiency of solvent recyclability or recovery achieved is further influenced by the correct and efficient selection of the downstream processing technique.

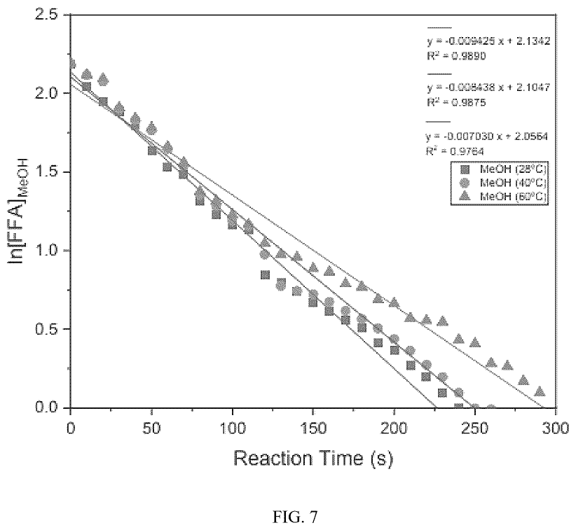

In preferred embodiments, FIG. 7 demonstrated the first-order model for methanol to characterize the relationship between the parameters. The analysis indicates that the first-order equation provides a satisfactory fit to the experimental data, as evidenced by the high coefficient of determination (R²) values obtained (0.9890) at room temperature (28° C.). This suggests that the first-order model adequately describes the kinetics of the conversion reaction under optimized conditions. This could be due to factors such as the nature of the reaction mechanism involved. For instance, if the rate-determining step of the reaction involves the collision of a methanol molecule with a free fatty acids (FFAs) molecule, then the reaction rate would be directly proportional to the concentration of the FFA s.

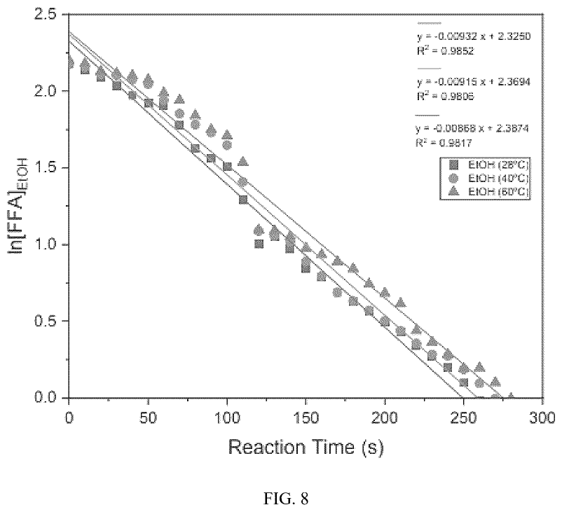

In preferred embodiments, FIG. 8 demonstrated the first-order model for ethanol to characterize the relationship between the parameters. The analysis indicates that the first-order equation provides a satisfactory fit to the experimental data, as evidenced by the high coefficient of determination (R²) values obtained (0.9852) at room temperature (28° C.). This suggests that the first-order model adequately describes the kinetics of the conversion reaction under optimized conditions. Ethanol has different solvent properties, such as polarity and hydrogen bonding capabilities. These differences can influence the solubility and accessibility of reactants, as well as the stability of intermediates and transition states involved in the kinetic reaction. For instance, if the rate-determining step of the reaction involves the collision of ethanol molecule with a free fatty acids (FFAs) molecule, then the reaction rate would be directly proportional to the concentration of the FFAs.

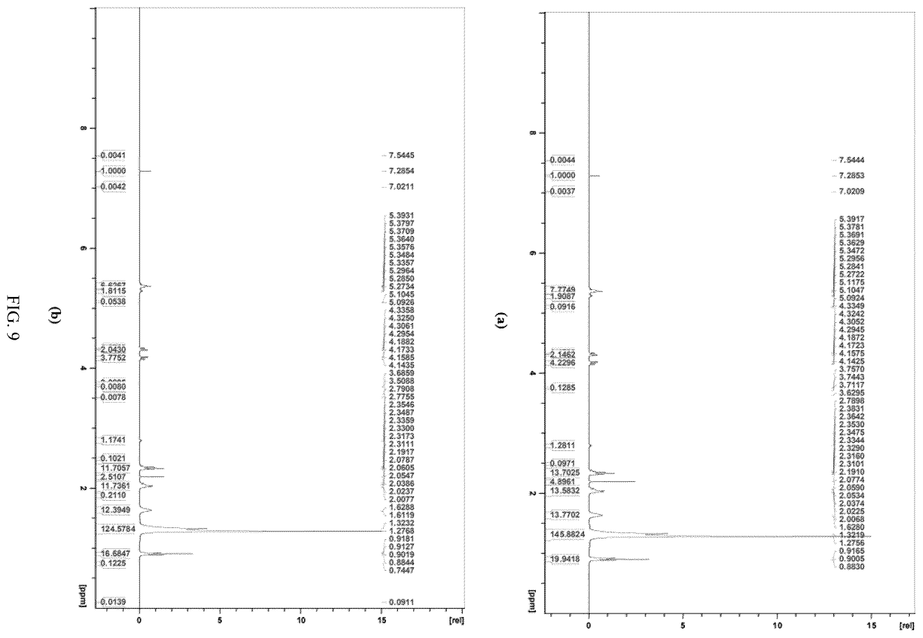

In preferred embodiments, FIGS. 9A and 9B demonstrated Nuclear magnetic resonance spectroscopy (NMR) results of crude palm oil (CPO) and treated oil when mixing with methanol. NMR analysis of CPO and its reaction with methanol reveals shifts in peaks corresponding to fatty acids and glycerol, indicating esterification reaction. Peaks related to esters diminish, signifying triglyceride conversion. Changes in peak intensities provide insights into conversion rates and fatty acid composition without disturbing the fatty acid profiles of the CPO.

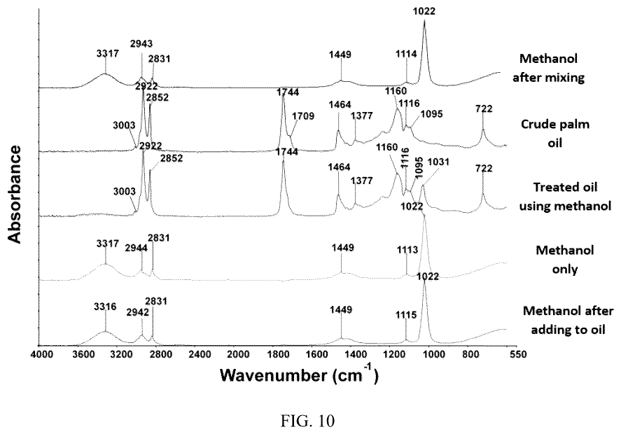

In preferred embodiments, FIG. 10 demonstrated Fourier-transform infrared spectroscopy (FTIR) results of crude palm oil (CPO) and treated oil when mixing with methanol. CPO and treated oil using methanol did not show any (—OH) group for alcohol present indicating that there was no water or alcohol remaining in the treated sample. There is some similarity between CPO and the treated oil using methanol in many functional groups, however, there are obvious difference at the 1030 cm¹ indicating the presence of ═C—O—C symmetric stretching and C—O for primary alcohol. Additionally, the peak at 1713 cm⁻¹ indicating the presence of —C═O for the aldehyde in the CPO disappeared in the treated oil. Likely reasons include its reaction with other constituents in methanol and structural changes, reflecting significant changes in the oil chemical composition.

In preferred embodiments, Table 1 demonstrated gas chromatography/mass spectrometry (GC/MS) results of initial crude palm oil (CPO) and treated oil when mixing with methanol at lab scale. This result signifies a conversion process primarily involving the transformation of free fatty acids (FFAs) into triglycerides. M ethanol acts as a reactant in esterification, wherein monoglycerides, diglycerides, and triglycerides are consumed in the reaction, leading to the formation of triglycerides. As triglycerides are formed, the equilibrium shifts towards the products, resulting in a decrease in the concentrations of monoglycerides, diglycerides, and free glycerin as they are converted into triglycerides. Thus, their decrease contents can be attributed to the conversion of FFA into triglycerides through the esterification process catalyzed by methanol.

TABLE 1

| | | Initial Crude | Treated Crude |
|---|---|---|---|
| Parameter | Unit | Palm Oil (CPO) | Palm Oil (CPO) |
| Monoglyceride content | % (m/m) | 2.33 | 0.04 |
| Diglyceride content | % (m/m) | 17.55 | 7.84 |
| Triglyceride content | % (m/m) | 51.56 | 68.55 |
| Free glycerine | % (m/m) | 0.04 | <0.01 |
| Total glycerine | % (m/m) | 8.50 | 8.21 |
| Ester content | % (m/m) | 0.32 | 0.68 |

In preferred embodiments, Table 2 demonstrated pH value results of methanol after mixing with crude palm oil (CPO). The rapid decrease in methanol pH upon introduction to CPO indicates probable migration of free fatty acids (FFA) or protons into the methanol phase. This phenomenon suggests proton transfer from FFA to methanol, increasing acidity. Additionally, esterification reactions between FFA and methanol release protons, further lowering pH value.

TABLE 2

| pH value of Methanol | After reaction |
|---|---|
| 7.46 | 4.93 |
| 7.44 | 4.83 |
| 7.44 | 4.04 |
| 7.63 | 5.27 |
| 8.6 | 5.12 |
| 7.47 | 5.01 |
| 7.48 | 4.93 |

In preferred embodiments, Table 3a and 3b demonstrated conductivity results of methanol after mixing with crude palm oil (CPO). Observations indicate that lower loading of methanol and ethanol at higher temperature (60° C.) (Table 3a) resulted in higher conductivity values after 30 minutes compared at room temperature (Table 3b). The observed trend can be attributed to increase ion mobility. After approximately 10 minutes, a noticeable upward trend in conductivity was observed for both methanol/ethanol. The conductivity of both methanol/ethanol continued to rise and reached a stable plateau after approximately 25 minutes. The increasing trend in conductivity over time for both methanol/ethanol can be explained by the gradual ionization of methanol/ethanol molecules in the liquid state. As time progresses, more methanol/ethanol molecules ionize, leading to a higher concentration of charge carriers, and subsequently, increased electrical conductivity.

TABLE 3a

| Time (Min) | MeOH 60° C. | EtOH 60° C. |
|---|---|---|
| 0 | 0.033 | 0.112 |
| 5 | 0.075 | 0.136 |
| 10 | 0.186 | 0.149 |
| 15 | 0.207 | 0.159 |
| 20 | 0.216 | 0.168 |
| 25 | 0.223 | 0.202 |
| 30 | 0.224 | 0.205 |

TABLE 3b

| Time (Min) | MeOH 28° C. | EtOH 28° C. |
|---|---|---|
| 0 | 0.058 | 0.118 |
| 5 | 0.092 | 0.132 |
| 10 | 0.137 | 0.142 |
| 15 | 0.152 | 0.149 |
| 20 | 0.161 | 0.153 |
| 25 | 0.167 | 0.160 |
| 30 | 0.169 | 0.163 |

In preferred embodiments, Table 4 demonstrated initial and final of free fatty acids (FFAs) upon mixing with methanol. The reduction in FFAs observed after mixing with methanol can be linked to their conversion into triglycerides through esterification. As FFAs are consumed in this process to produce triglycerides, their initial high levels decrease significantly. The decrease in FFAs occurs because the formation of triglycerides from FFAs shifts the equilibrium towards product formation as proven by the GC-MS results.

TABLE 4

| Initial Free Fatty Acids | Final Free Fatty Acids |
|---|---|
| (FFAs)(%) | (FFAs)(%) |
| 55 | 19 |
| 48 | 14 |
| 10 | 2.5 |
| 3.45 | 0.15 |

In preferred embodiments, Table 5 demonstrated the pilot plant results, with a processing capacity of 1 gallon/hour, demonstrated remarkable efficiency in improving the quality of crude palm oil (CPO). Significant reduction in free fatty acid (FFA) content, which decreased from an initial level of 17.88% to 0.6%, was achieved. This significant reduction indicates the effectiveness of the process in removing unwanted acidic components. Alongside this, the triglyceride (TGA) content increased significantly from 71.76% to 95.64%, indicating a successful conversion of FFAs into valuable triglycerides, likely through esterification reactions. Moreover, the levels of diglycerides (DGA) and monoglycerides (MGA) were reduced from 10% and 0.36% to 3.7% and 0.05%, respectively. This shift highlights a more complete transformation into triglycerides and an overall enhancement in oil purity.

TABLE 5

| | | Initial crude | Treated crude |
|---|---|---|---|
| Analysis | Unit | palm oil (CPO) | palm oil (CPO) |
| Triglyceride (TGA) | % | 71.76 | 95.64 |
| Diglyceride (DGA) | % | 10 | 3.71 |
| Monoglyceride (MGA) | % | 0.36 | 0.05 |
| Free fatty acid (FFA) | % | 17.88 | 0.6 |

In preferred embodiments, Table 6 presents the characterization analysis of initial and treated crude palm oil (CPO), revealing notable improvements in several key quality indicators. The reduction in E233 and E269 values from 2.44 to 2.15 and 1.01 to 0.67, respectively, indicates a decrease in primary and secondary oxidation products, reflecting better oxidative stability. The UV totox value also dropped from 3.45 to 2.82, further confirming reduced total oxidation. A significant decrease in peroxide value from 2.70 to 0.92 meq/kg suggests the removal or degradation of hydroperoxides, the primary oxidation compounds. Meanwhile, the slight reduction in iodine value (IV) from 51.72 to 51.01 indicates minimal impact on unsaturation levels, maintaining the oil's nutritional and chemical characteristics. This illustrates the utility of the methods disclosed herein to recycle an acidic oil, thereby neutralizing the oil by reducing the FFAs and improving other quality characteristics of the oil for reuse.

TABLE 6

| | Initial crude | Treated crude |
|---|---|---|
| Analysis | palm oil (CPO) | palm oil (CPO) |
| E233 | 2.44 | 2.15 |
| E269 | 1.01 | 0.67 |
| UV Totox | 3.45 | 2.82 |
| Peroxide value (meq/kg oil) | 2.70 | 0.92 |
| Iodine value (IV) | 51.72 | 51.01 |

In preferred embodiments, Table 7 demonstrated the fatty acid profile of crude palm oil (CPO) showed slight changes after treatment. The major saturated fatty acids, particularly palmitic acid (C16), increased slightly from 44.237% to 44.528%, while other saturated fatty acids such as lauric (C12) and myristic acid (C14) showed minor reductions. Stearic acid (C18) also increased slightly from 4.375% to 4.532%. Among the unsaturated fatty acids, oleic acid (C18:1) remained relatively stable, decreasing slightly from 39.551% to 39.485%, while linoleic acid (C18:2) decreased from 9.587% to 9.211%. A slight increase was observed in linolenic acid (C18:3), from 0.334% to 0.340%, and arachidic acid (C20) slightly increased from 0.603% to 0.651%. Overall, the fatty acid profile remains almost the same without a significant change, indicating that the process did not significantly alter its nutritional or chemical properties.

TABLE 7

| | | Initial crude | Treated crude |
|---|---|---|---|
| Analysis | Unit | palm oil (CPO) | palm oil (CPO) |
| C12 | % | 0.113 | 0.088 |
| C14 | % | 0.961 | 0.945 |
| C16 | % | 44.237 | 44.528 |
| C16-1 | % | 0.241 | 0.222 |
| C18 | % | 4.375 | 4.532 |
| C18-1 | % | 39.551 | 39.485 |
| C18-2 | % | 9.587 | 9.211 |
| C20 | % | 0.603 | 0.651 |
| C18-3 | % | 0.334 | 0.340 |

In preferred embodiments, Table 8 demonstrated the analysis of contaminants in crude palm oil (CPO) before and after treatment shows a significant improvement in safety and quality. The total chlorine (TC) content decreased distinctly from 2.649 ppm in the initial CPO sample to 1.232 ppm in the treated sample, indicating the effective removal of chlorine containing compounds. This reduction is crucial, as chlorine is a precursor for the formation of 3-monochloropropanediol (3-MCPD), a harmful contaminant formed during oil processing. Consequently, 3-M CPD levels were also significantly reduced from 1.545 ppm to 0.57 ppm, reflecting the success of the treatment process in lowering health related risks.

TABLE 8

| | Initial crude | Treated crude |
|---|---|---|
| Sample | palm oil (CPO) | palm oil (CPO) |
| Total Chlorine (ppm) | 2.649 | 1.232 |
| 3-monochloropropanediol, | 1.545 | 0.57 |
| 3-MCPD (ppm) | | |

1. A method comprising for converting free fatty acids (FFAs) to triacylglyceride to decrease the FFA percentage in an acidic oil, comprising the steps of
a) mixing an acidic oil with an organic solvent creating a neutralized oil;
b) separating the neutralized oil from the organic solvent; and
c) evaluating the neutralized oil.

2. The method on claim 1 wherein FFAs or monoglycerides and diglycerides present in the acidic oil are converted to triacylglycerides during the mixing.

3. The method on claim 1 wherein the acidic oil is a vegetables oil, a waste cooking oil, or an animal fat.

4. The method of claim 3 wherein the vegetable oil includes rapeseed oil, canola oil, soybean oil, camellia oil, algae oil, sesame oil, mustard seed oil, linseed oil, corn oil, crude palm oil, sludge palm oil, acidic crude palm oil, low grade palm oil, palm-kernel oil, jatrophra seed oil, Nahar (Mesua ferrea) seed oil, balanites aegyptiaca seed oil, kenaf seed oil, squash seed oil, watermelon seed oil, pumpkin seed oil, cottonseed oil, safflower oil, perilla seed oil, black seed oil, cocoa seed oil, neem oil, rubber seed oil, flaxseed oil, argan oil, almond oil, hazelnut oil, paradise oil, copaiba oil, okra seed oil, babassu oil, castor oil, tung oil, microalgae oil, rice bran oil, coconut oil, poppy-seed oil, sunflower oil, castor oil, jojoba oil, avocado oil, seaweed oil, walnut oil, grape seed oil, peanut oil, olive oil.

5. The method on claim 3 wherein the waste cooking oil includes, brown grease, yellow grease, choice white grease.

6. The method of claim 3 wherein the animal fat includes, tallow, lard, poultry fat and fish oil.

7. The method of claim 1 wherein the organic solvent is a C1 and C13 alcohol.

8. The method of claim 7 wherein the organic solvent is ethanol.

9. The method of claim 7 wherein the organic solvent is methanol.

10. The method of claim 1 wherein the steps take place in atmospheric pressure.

11. The method of claim 1 wherein the ratio of organic solvent to acidic oil is about 40:1 to about 1000:1.

12. The method of claim 1 wherein the reaction time is about 60 seconds to 900 seconds.

13. The method of claim 1 wherein the acidic oil is heated prior to mixing.

14. The method of claim 13 wherein the acidic oil is heated to about 40° C. to about 80° C. prior to mixing.

15. The method of claim 13 wherein the ratio of organic solvent to acidic consumable oil is about 40:1 to about 1000:1.

16. The method of claim 1 or claim 13 wherein after separation in step c, the organic solvent is recycled for use in step b.

17. The method of claim 15 wherein the organic solvent is recycled 1 to 10 times.

18. A method for recycling acidic consumable oil comprising the steps of
a) heating the acidic consumable oil in need of recycling;
b) mixing an acidic oil with an organic solvent creating a neutralized oil;
c) separating the neutralized oil from the organic solvent; and
d) evaluating the FFA content of the neutralized oil for an FFA content less than 2%

19. The method of claim 18 wherein the acidic oil is heated to about 40° C. to about 80° C. prior to mixing.

20. The method of claim 18 wherein the ratio of organic solvent to acidic consumable oil is about 40:1 to about 1000:1.
